(19) United States
(12) Patent Application Publication
(10) Pub. No.: US 2026/0204605 A1
(43) Pub. Date: Jul. 16, 2026

(54) MALFUNCTION DETECTION AND DETERIORATION ESTIMATION DEVICE

(71) Applicants: KABUSHIKI KAISHA TOYOTA CHUO KENKYUSHO, Nagakute-shi, Aichi-ken (JP); DENSO CORPORATION, Kariya-shi, Aichi-ken (JP)

(72) Inventors: Ryoichi HIBINO, Nagakute-shi (JP); Norihiro FUKAYA, Nagakute-shi (JP); Takao WATANABE, Nagakute-shi (JP); Takashi YAMADA, Kariya-shi (JP); Naoyuki YAMADA, Kariya-shi (JP)

(73) Assignees: KABUSHIKI KAISHA TOYOTA CHUO KENKYUSHO, Nagakute-shi, Aichi-ken (JP); DENSO CORPORATION, Kariya-shi, Aichi-ken (JP)

(21) Appl. No.: 19/137,970

(22) PCT Filed: Nov. 13, 2023
(86) PCT No.: PCT/JP2023/040704

§ 371 Date: Jun. 11, 2025

(30) Foreign Application Priority Data
Feb. 20, 2023 (JP) 2023-024209

(51) Int. Cl. H01M 8/04664; H01M 8/04298; H01M 8/0432; H01M 8/04537; H01M 8/04992

(52) U.S. Cl. CPC H01M 8/04671; H01M 8/04305; H01M 8/0432; H01M 8/04552; H01M 8/04582; H01M 8/04992

(57) ABSTRACT

Output data including an FC current i(t), a first cell voltage V₁(t), a first feature amount X₁(t), and a second feature amount X₂(t) of a fuel cell at a time t is obtained sequentially. Next, from among output data, time t and first cell voltage V₁(t) when FC current i(t) is a representative current iᵣ are extracted, and a representative I-V characteristic V_{f}(t, iᵣ) is calculated using these. Next, from among output data, time t, first feature amount X₁(t), and the second feature amount X₂(t) when the FC current i(t) is the representative current iᵣ are extracted, and a temporary fluctuation Yₘ(X₁, X₂) in cell voltage is calculated using these. Next, an average I-V characteristic Vₘₑₐₙ(t, iᵣ) at the time t is calculated by subtracting Yₘ(X₁, X₂) from V_{f}(t, iᵣ). Further, it is determined on the basis of Vₘₑₐₙ(t, iᵣ) whether or not the fuel cell has malfunctioned or deteriorated.

### FIELD OF THE INVENTION

The present invention relates to a malfunction detection and deterioration estimation device, and more specifically to a malfunction detection and deterioration estimation device capable of detecting abnormalities or malfunction in a fuel cell with high accuracy and at an earlier stage, or estimating the degree of deterioration of the fuel cell.

### BACKGROUND OF THE INVENTION

A polymer electrolyte fuel cell (hereinafter simply referred to as a “fuel cell”) is equipped with a membrane electrode assembly (MEA) in which catalyst layers containing electrode catalysts are bonded to both surfaces of an electrolyte membrane. The catalyst layer is a portion which serves as a reaction field for electrode reaction, and generally consists of a composite including carbon supporting catalyst particles such as platinum and a solid polymer electrolyte (catalyst layer ionomer).

In a fuel cell, a gas diffusion layer is usually arranged outside the catalyst layer. A current collector (separator) equipped with a gas flow path is further arranged outside the gas diffusion layer. The fuel cell usually has a structure (fuel cell stack) in which a plurality of unit cells each consisting of such an MEA, gas diffusion layer, and current collector are stacked.

When the fuel cell is used as an on-vehicle power source, the voltage of the fuel cell fluctuates greatly depending on the driving conditions of the vehicle. When the fuel cell is in a low-load state, the cathode catalyst is exposed to a high potential state, thereby making it easier for catalytic components to dissolve from the cathode catalyst. On the other hand, when the fuel cell is in a high-load state, the cathode catalyst is exposed to a low potential state, thereby making it easier for the dissolved catalytic components to re-deposit on the surface of the cathode catalyst. Therefore, when the cathode catalyst is repeatedly exposed to the high and low potential states, the cathode catalyst gradually deteriorates. When the cathode catalyst deteriorates, the cell voltage of the fuel cell also decreases.

On the other hand, there is a case where the cell voltage of a fuel cell drops due to causes other than the aging deterioration of such an electrode catalyst. In this case, if it is possible to find the cause of the drop in cell voltage early, there is a possibility that the costs required for the maintenance and inspection of the fuel cell can be reduced. Therefore, various proposals have been made conventionally regarding the malfunction detection of the fuel cell.

For example, Patent Literature 1 discloses a fuel cell monitoring system of
(a) calculating an effective electrode area of a fuel cell so that an effective value of a fuel cell stack voltage in fuel cell system coincides with a simulation result obtained by a simulator, and
(b) determining that an abnormality has occurred when the effective electrode area deviates from the normal range.

The literature describes that such a system can significantly reduce man-hour required for maintenance and accurately monitor a deterioration state inside the fuel cell power generation system.

The output of the fuel cell usually changes from moment to moment. Therefore, when the cell voltage measured under specific conditions drops, it is difficult to distinguish, based only on the actual change in cell voltage, whether or not the drop in cell voltage is due to the aging deterioration of the electrode catalyst or due to events (i.e., an abnormality or malfunction of the fuel cell) other than it.

In this regard, Patent Literature 1 describes that the presence or absence of an abnormality can be detected depending on whether the effective electrode area deviates from the normal range. However, in Patent Literature 1, the effective electrode area is estimated from the effective value of the cell voltage, and a temporary fluctuation in cell voltage is not taken into consideration. Therefore, the voltage drop due to the temporary fluctuation in cell voltage may be judged as a decrease in the effective electrode area, and there is a risk that an abnormality may be mistakenly determined to have occurred even when the fuel cell is normal.

Further, there has been no conventional proposals for an apparatus capable of highly accurately estimating the presence or absence of malfunction in a fuel cell and the degree of deterioration thereof.

### CITATION LIST

### Patent Literature

[Patent Literature 1] Japanese Unexamined Patent Application Publication No. 2007-305327

### SUMMARY OF THE INVENTION

A problem to be solved by the present invention is to provide a malfunction detection and deterioration estimation device which is capable of detecting abnormalities or malfunction in a fuel cell with high accuracy and at an earlier stage, even when a cell voltage repeats a temporary fluctuation, or estimating the degree of deterioration of the fuel cell with high accuracy.

To solve the above problem, a malfunction detection and deterioration estimation device according to the present invention includes the following configurations:
(A) first means for sequentially obtaining output data of a fuel cell at a time t, the output data including
(a) an FC current i(t),
(b) a first cell voltage V₁(t),
(c) a first feature amount X₁(t) including any one or more selected from a group consisting of a second cell voltage V₂(t) and parameters correlated therewith, and
(d) a second feature amount X₂(t) including any one or more selected from a group consisting of an outside air temperature T(t) and parameters correlated therewith, and
storing the output data in a memory,
where the “first cell voltage V₁(t)” refers to among cell voltages of the fuel cell at all times, the cell voltage when the fuel cell is in an intermittent operation OFF state, and the “second cell voltage V₂(t)” refers to the cell voltages of the fuel cell at all times;
(B) second means for extracting from the output data, the time t and the first cell voltage V₁(t) when the FC current i(t) is a representative current iᵣ, calculating a representative I-V characteristic V_{f}(t, iᵣ) using these, and storing the same in the memory;
(C) third means for extracting from the output data, the time t, the first feature amount X₁(t), and the second feature amount X₂(t) when the FC current i(t) is the representative current iᵣ, calculating a temporary fluctuation Yₘ(X₁, X₂) in cell voltage using these, and storing the same in the memory;
(D) fourth means for calculating an average I-V characteristic Vₘₑₐₙ(t, iᵣ) at the time t by subtracting Yₘ(X₁, X₂) from V_{f}(t, iᵣ), and storing the same in the memory; and
(E) fifth means for determining whether or not the fuel cell has malfunctioned or deteriorated, on the basis of Vₘₑₐₙ(t, iᵣ).

First, the FC current i(t), the first cell voltage V₁(t), the first feature amount X₁(t), and the second feature amount X₂(t), which change from moment to moment, are obtained and stored in the memory.

Next, the time t and V₁(t) when the FC current i(t) is a representative current iᵣ (for example, when iᵣ=0.2 A/cm²) are read from the memory, and the change in cell voltage over time when i(t) is iᵣ, i.e., the representative I-V characteristic V_{f}(t. iᵣ) is calculated.

Similarly, the time t, X₁(t), and X₂(t) when the FC current i(t) is the representative current iᵣ are read from the memory, and the temporary fluctuation Yₘ(X₁, X₂) in cell voltage when i(t) is iᵣ is calculated.

Further, the average I-V characteristic Vₘₑₐₙ(t, iᵣ) is calculated by subtracting Yₘ(X₁, X₂) from the obtained V_{f}(t, iᵣ).

Upon non-malfunction, V_{f}(t, iᵣ) includes the drop in cell voltage due to the aging deterioration of the electrode catalyst, and the temporary fluctuation Yₘ(X₁, X₂) in cell voltage. Also, when the fuel cell malfunctions, V_{f}(t, iᵣ) is further added with the drop in cell voltage due to the malfunction. Therefore, even if malfunction diagnosis is performed using only V_{f}(t, iᵣ), it is difficult to perform accurate malfunction diagnosis.

In contrast, when there is no malfunction, Vₘₑₐₙ(t, iᵣ) includes only the drop in cell voltage due to the aging deterioration of the electrode catalyst. Further, when the fuel cell malfunctions, Vₘₑₐₙ(t, iᵣ) is further added with the drop in cell voltage due to the malfunction. Therefore, if the change in Vₘₑₐₙ(t, iᵣ) is monitored sequentially, it is possible to determine the presence or absence of the malfunction from the amount of change in Vₘₑₐₙ(t, iᵣ). On the other hand, when no malfunction is detected, it is possible to estimate the deterioration of the fuel cell and the IV performance on the basis of Vₘₑₐₙ(t, iᵣ).

### BRIEF DESCRIPTION OF THE DRAWINGS

FIG. 1A is a schematic diagram of a decrease in cell voltage due to aging deterioration of an electrode catalyst.

FIG. 1B is a schematic diagram of an actual decrease in cell voltage.

FIG. 2A is a schematic diagram of a change in cell voltage when a malfunction occurs in the case where the change in cell voltage includes only a decrease in cell voltage due to aging deterioration of the electrode catalyst.

FIG. 2B is a schematic diagram of a change in cell voltage when a malfunction occurs in the case where the change in cell voltage includes a decrease in cell voltage due to aging deterioration of the electrode catalyst and a temporary fluctuation in cell voltage.

FIG. 3 is a schematic diagram of a method for calculating an I-V characteristic at an arbitrary time t from driving data of a vehicle quipped with a fuel cell.

FIG. 4A is an example of a change over time of a representative I-V characteristic V_{f}(t, iᵣ) when a representative current iᵣ is 0.2 A/cm².

FIG. 4B is an example of a change over time of a representative I-V characteristic V_{f}(t, iᵣ) when the representative current iᵣ is 0.4 A/cm².

FIG. 5 is a schematic diagram of a method for calculating Yₘ(X₁, X₂) using a neural network.

FIG. 6A is a schematic diagram of a malfunction detection method using the rate of decrease dVₘₑₐₙ(t, iᵣ)/dt of Vₘₑₐₙ(t, iᵣ) at a time t and the rate of decrease dVₘₑₐₙ(t−m, iᵣ)/dt of Vₘₑₐₙ(t−m, iᵣ) at a time (t−m).

FIG. 6B is a schematic diagram of a malfunction detection method using only the rate of decrease dVₘₑₐₙ(t, iᵣ)/dt of Vₘₑₐₙ(t, iᵣ) at a time t.

FIG. 7 is a schematic diagram of a malfunction detection method using a non-malfunction model Vₙ(t, iᵣ).

### DETAILED DESCRIPTION OF PREFERRED EMBODIMENTS

An embodiment of the present invention will hereinafter be described in detail.

### 1. Malfunction Detection and Deterioration Estimation Method

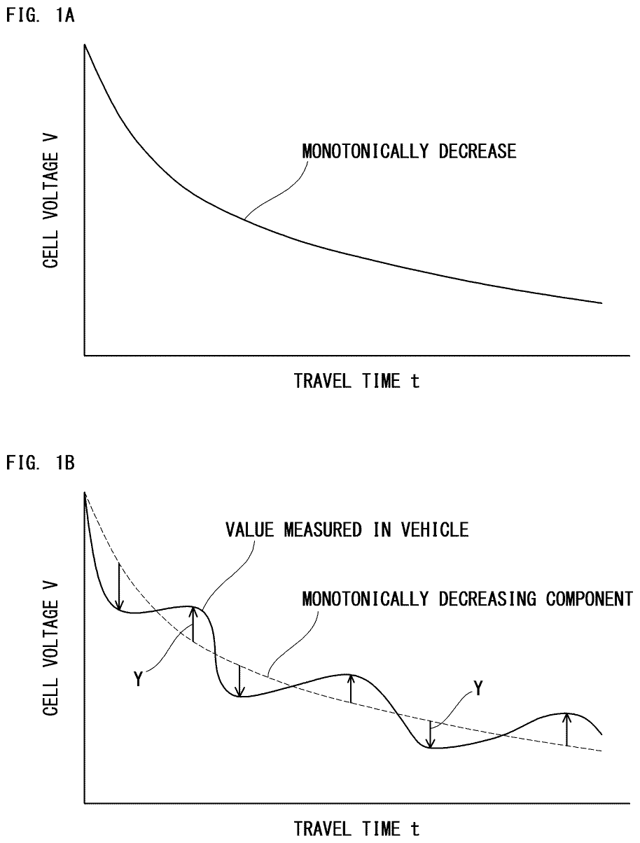

The malfunction detection and deterioration estimation method according to the present invention will be described below for an FC system applied in a vehicle. FIG. 1A shows a schematic diagram of a decrease in cell voltage due to aging deterioration of an electrode catalyst. FIG. 1B shows a schematic diagram of an actual decrease in cell voltage.

The platinum catalyst used in FC stacks deteriorates as the vehicle travels. Therefore, ideally, the cell voltage V measured under specific conditions will monotonically decrease with the elapse of a travel time t as shown in FIG. 1A.

However, the cell voltage measured in an actual vehicle contains, as shown in FIG. 1B, a monotonically decreasing component due to deterioration of the catalyst over time, as well as a component Y in which the cell voltage temporarily fluctuates around this monotonically decreasing waveform.

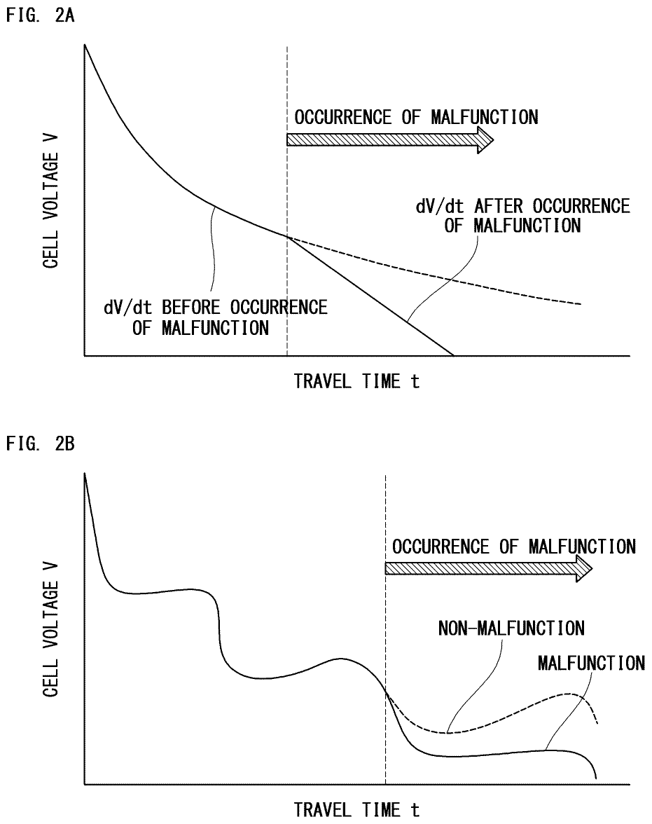

FIG. 2A shows a schematic diagram of a change in cell voltage when a malfunction occurs in the case where the change in cell voltage includes only a decrease in cell voltage due to aging deterioration of the electrode catalyst. FIG. 2B shows a schematic diagram of a change in cell voltage when a malfunction occurs in the case where the change in cell voltage includes a decrease in cell voltage due to aging deterioration of the electrode catalyst and a temporary fluctuation in cell voltage.

If the change in the measured cell voltage V contains only a monotonically decreasing component due to the aging deterioration of the electrode catalyst as shown in FIG. 1A, the slope dV/dt of a monotonically decreasing curve changes continuously with the elapse of time. However, when a malfunction occurs at a certain time t, dV/dt changes discontinuously as shown in FIG. 2A. Therefore, if the change in dV/dt is sequentially monitored, the presence or absence of a malfunction can be determined from the presence or absence of a discontinuous change in dV/dt.

However, as shown in FIG. 1B, the cell voltage actually measured contains a temporarily fluctuating component Y. Therefore, as shown in FIG. 2B, simply monitoring the actually measured cell voltage makes it difficult to distinguish whether a fluctuation in the measured cell voltage is due to a cause other than a malfunction (temporary cell voltage fluctuation) or due to a malfunction.

Therefore, in the present invention, the temporary cell voltage fluctuation is estimated using various methods, and the decreasing component of the cell voltage due to the aging deterioration of the electrode catalyst (monotonically decreasing component) is separated by subtracting the temporary cell voltage fluctuation component from the actually measured cell voltage. The presence or absence of a malfunction is then determined on the basis of the change over time of the separated monotonically decreasing component. This is different from the conventional one. The details of the separation method and the determination method will be described later.

### 2. Malfunction Detection and Deterioration Estimation Device

The malfunction detection and deterioration estimation device according to the present invention has the following configuration.

### Configuration 1

A malfunction detection and deterioration estimation device including the following configurations:
(A) first means for sequentially obtaining output data of a fuel cell at a time t, the output data including
(a) an FC current i(t),
(b) a first cell voltage V₁(t),
(c) a first feature amount X₁(t) including any one or more selected from a group consisting of a second cell voltage V₂(t) and parameters correlated therewith, and
(d) a second feature amount X₂(t) including any one or more selected from a group consisting of an outside air temperature T(t) and parameters correlated therewith, and
storing the output data in a memory,
where the “first cell voltage V₁(t)” refers to among cell voltages of the fuel cell at all times, the cell voltage when the fuel cell is in an intermittent operation OFF state, and
the “second cell voltage V₂(t)” refers to the cell voltages of the fuel cell at all times;
(B) second means for extracting from the output data, the time t and the first cell voltage V₁(t) when the FC current i(t) is a representative current iᵣ, calculating a representative I-V characteristic V_{f}(t, iᵣ) using these, and storing the same in the memory;
(C) third means for extracting from the output data, the time t, the first feature amount X₁(t), and the second feature amount X₂(t) when the FC current i(t) is the representative current iᵣ, calculating a temporary fluctuation Yₘ(X₁, X₂) in cell voltage using these, and storing the same in the memory;
(D) fourth means for calculating an average I-V characteristic Vₘₑₐₙ(t, iᵣ) at the time t by subtracting Yₘ(X₁, X₂) from V_{f}(t, iᵣ), and storing the same in the memory; and
(E) fifth means for determining whether or not the fuel cell has malfunctioned or deteriorated, on the basis of Vₘₑₐₙ(t, iᵣ).

### Configuration 2

The malfunction detection and deterioration estimation device according to the configuration 1, wherein
the parameters correlated with V₂(t) include any one or more selected from a group consisting of an FC intermittent operation flag, FC power, an air flow rate, a motor rotation speed of an air compressor, power consumption of a hydrogen pump, a rotation speed of the hydrogen pump, FC inlet pressure (anode), a rotation speed of an EV cooling water pump, a rotation speed of an FC cooling water pump, an FC converter current, power required for a vehicle system, a current value required for the vehicle system, FC inlet pressure (cathode), an anode gas flow rate, power consumption of the air compressor, an FC power generation status, and A/C power consumption.

### Configuration 3

The malfunction detection and deterioration estimation device according to the configuration 1 or 2, wherein
the parameters correlated with T(t) include any one or more selected from a group consisting of a coolant water temperature of a radiator outlet, a motor temperature of an air compressor, an inverter temperature of the air compressor, a motor temperature of a hydrogen pump, an FC outlet coolant water temperature, and a temperature of each auxiliary component.

### Configuration 4

The malfunction detection and deterioration estimation device according to any one of the configurations 1 to 3, wherein
the third means includes means for calculating Yₘ(X₁, X₂) using a following equation (2):

$${Y}_{m} ( {X}_{1} , {X}_{2} ) = {a}_{0} + Σ {a}_{1 p} {{X}_{1} ( t )}^{p} + Σ {a}_{2 q} {{X}_{2} ( t )}^{q} \qquad ( 2 )$$

where
p and q are each an integer of 1 or more, and
a₀, a₁ₚ, and a_{2q} are each a coefficient identified for each representative current iᵣ.

### Configuration 5

The malfunction detection and deterioration estimation device according to any one of the configurations 1 to 4, wherein
the third means includes means for calculating Yₘ(X₁, X₂) using a neural network.

### Configuration 6

The malfunction detection and deterioration estimation device according to any one of the configurations 1 to 5, wherein
the fifth means includes means for
sequentially calculating the rate of decrease dVₘₑₐₙ(t, iᵣ)/dt of Vₘₑₐₙ(t, iᵣ), and
determining that the fuel cell has malfunctioned when any one or more of following equations (3.1) to (3.6) are satisfied:

$$\vert {dv}_{m e a n} ( t , {i}_{r} ) / dt - d {v}_{m e a n} ( t - m , {i}_{r} ) / dt \vert > {ε}_{31} \qquad ( 3.1 )$$

$$\vert {dv}_{m e a n} ( t , {i}_{r} ) / dt - d {v}_{m e a n} ( t - m , {i}_{r} ) / dt \vert \geq {ε}_{31} \qquad ( 3.2 )$$

$$\vert [ {dv}_{m e a n} ( t , {i}_{r} ) / dt ] / [ {dv}_{m e a n} ( t - m , {i}_{r} ) / dt ] \vert > {ε}_{32} \qquad ( 3.3 )$$

$$\vert [ {dv}_{m e a n} ( t , {i}_{r} ) / dt ] / [ {dv}_{m e a n} ( t - m , {i}_{r} ) / dt ] \vert \geq {ε}_{32} \qquad ( 3.4 )$$

$$\vert {dv}_{m e a n} ( t , {i}_{r} ) / dt \vert > {ε}_{33} \qquad ( 3.5 )$$

$$\vert {dv}_{m e a n} ( t , {i}_{r} ) / dt \vert \geq {ε}_{33} \qquad ( 3.6 )$$

where
dVₘₑₐₙ(t−m, iᵣ)/dt is the rate of decrease of the average I-V characteristic Vₘₑₐₙ(t−m, iᵣ) at a time (t−m) (m>0), and
ε₃₁, ε₃₂, and ε₃₃ are thresholds for determining the presence or absence of a malfunction, respectively.

### Configuration 7

The malfunction detection and deterioration estimation device according to any one of the configurations 1 to 6, wherein
the memory stores a non-malfunction model Vₙ(t, iᵣ) when the FC current i(t) is the representative current iᵣ, and
the fifth means includes means for determining that the fuel cell has malfunctioned when any one or more of following equations (4.1) to (4.4) are satisfied:

$$\vert {V}_{m e a n} ( t , {i}_{r} ) - {V}_{n} ( t , {i}_{r} ) \vert > {ε}_{41} \qquad ( 4.1 )$$

$$\vert {V}_{m e a n} ( t , {i}_{r} ) - {V}_{n} ( t , {i}_{r} ) \vert \geq {ε}_{41} \qquad ( 4.2 )$$

$$\vert {V}_{m e a n} ( t , {i}_{r} ) / {V}_{n} ( t , {i}_{r} ) \vert < {ε}_{42} \qquad ( 4.3 )$$

$$\vert {V}_{m e a n} ( t , {i}_{r} ) / {V}_{n} ( t , {i}_{r} ) \vert \leq {ε}_{42} \qquad ( 4.4 )$$

where the “non-malfunction model Vₙ(t, iᵣ)” is a model indicating the relationship between a use history of a fuel cell with the same specifications as the fuel cell being the subject of malfunction detection and deterioration estimation, and a drop in cell voltage due to aging deterioration of an electrode catalyst, and
ε₄₁ an ε₄₂ are thresholds for determining the presence or absence of a malfunction.

### Configuration 8

The malfunction detection and deterioration estimation device according to the configuration 7, wherein
Vₙ(t, iᵣ) is
(a) a physical model or
(b) a model in which V_{f}(t, iᵣ) from time zero to the time t is approximated by an r order polynomial (where r is an integer being 1 or higher or 10 or lower).

### 2.1. First Means

The first means includes means for sequentially obtaining output data of the fuel cell at the time t, the output data including
(a) an FC current i(t),
(b) a first cell voltage V₁(t),
(c) a first feature amount X₁(t) including any one or more selected from a group consisting of a second cell voltage V₂(t) and parameters correlated therewith, and
(d) a second feature amount X₂(t) including any one or more selected from a group consisting of an outside air temperature T(t) and parameters correlated therewith, and storing the output data in a memory.

### 2.1.1. Fuel Cell

In the present invention, the type of fuel cell is not particularly limited. Fuel cells to which the present invention is applied include, for example, a polymer electrolyte fuel cell, a solid oxide fuel cell, etc.

[2.1.2. FC Current i(t)]

The FC current i(t) is used when selecting data used for malfunction detection and deterioration estimation.

Normally, when the FC current i(t) changes even if the deterioration state of the fuel cell is the same, the cell voltage V(t) also changes correspondingly. Therefore, in order to accurately perform the malfunction detection and deterioration estimation, there is a need to use the cell voltage V(t) when the FC current i(t) is a certain specified value.

In the present invention, the cell voltage V(t) when the FC current i(t) is a certain specified value (representative current iᵣ) is extracted from the stored data, and the extracted cell voltage V(t) is used to perform the malfunction detection and deterioration estimation. This point will be described below.

[2.1.3. First cell voltage V₁(t)]

The “first cell voltage V₁(t)” refers to among the cell voltages of the fuel cell at all times, the cell voltage when the fuel cell is in an intermittent operation OFF state.

V₁(t) is used to calculate the representative I-V characteristic V_{f}(t, iᵣ) as will be described below. In other words, V₁(t) is used to estimate the aging deterioration of the electrode catalyst.

For example, a fuel cell vehicle is usually equipped with a fuel cell and a secondary battery as a power source. In this case, the fuel cell does not generate power at all times, but repeats between a state in which power is being generated (intermittent operation OFF state) and a state in which power generation is stopped (intermittent operation ON state) depending on the power required for the vehicle. Therefore, when V_{f}(t, iᵣ) is calculated inclusive of not only the cell voltage when the fuel cell is generating power but also the cell voltage when the fuel cell is stopped, it is not possible to accurately estimate the decrease in cell voltage due to the aging deterioration of the electrode catalyst. Therefore, V₁(t) is used to calculate V_{f}(t, iᵣ).

### [2.1.4. First Feature Amount X₁(t)]

The “first feature amount X₁(t)” refers to any one or more parameters selected from a group consisting of a second cell voltage V₂(t) and parameters correlated therewith.

The “correlated parameter” refers to a parameter which can be identified as being equivalent as the second cell voltage V₂(t), or a parameter which can be converted to the second cell voltage V₂(t).

The “second cell voltage V₂(t)” refers to the cell voltages of the fuel cell at all times. That is, the second cell voltage V₂(t) includes not only the cell voltage when the fuel cell is generating power (when the intermittent operation is OFF), but also the cell voltage when the fuel cell is stopped (when the intermittent operation is ON).

X₁(t) is one of two parameters for calculating the temporary fluctuation Yₘ(X₁, X₂) in cell voltage as will be described later.

One of the main causes of the temporary fluctuation in cell voltage is a fluctuation in the power required for the fuel cell. Further, the fluctuation in the required power mainly appears as a fluctuation in V₂(t). Therefore, V₂(t) has a strong correlation with the temporary cell voltage fluctuation. By using V₂(t) as X₁(t), Yₘ(X₁, X₂) can be estimated with high accuracy.

Note that when estimating Yₘ(X₁, X₂), another parameter correlated with V₂(t) may be used as the first feature amount X₁(t) instead of or in addition to V₂(t).

Specific examples of such parameters include the following. For X₁(t), any one of the following parameters may be used, or two or more of the parameters may be used in combination.
(a) A flag indicating the intermittent operation state of the fuel cell (FC intermittent operation flag).
(b) Electric power generated in the fuel cell (FC power).
(c) The flow rate of air supplied to the cathode of the fuel cell (air flow rate).
(d) The motor rotation speed of the air compressor for supplying air to the cathode of the fuel cell.
(e) Power consumption of the hydrogen pump for supplying hydrogen to the anode of the fuel cell.
(f) The rotation speed of the hydrogen pump for supplying hydrogen to the anode of the fuel cell.
(g) The pressure of hydrogen supplied to the anode of the fuel cell (FC inlet pressure (anode)).
(h) The rotation speed of the pump for supplying coolant water to the drive system such as the motor and inverter (the rotation speed of the EV cooling water pump).
(i) The rotation speed of the cooling water pump for supplying coolant water to the fuel cell (the rotation speed of the FC cooling water pump).
(j) Converter current for FC.
(k) Power required for vehicle system.
(l) Current value required for vehicle system.
(m) The pressure of the air supplied to the cathode of the fuel cell (FC inlet pressure (cathode)).
(n) The flow rate of hydrogen supplied to the anode of the fuel cell (anode gas flow rate).
(o) Power consumption of the air compressor for supplying air to the cathode of the fuel cell.
(p) FC power generation status (power generation, non-power generation, start-up, completion sequence, etc.).
(q) Power consumption of air conditioning (A/C power consumption).

For example, when X₁(t) is an FC intermittent operation flag, the flag is set to “1” when the fuel cell is in operation, and to “0” when the fuel cell is in a stopped state. In this case, when the fluctuation in the FC intermittent operation flag with the elapse of time is subjected to average processing, the averaged fluctuation in the FC intermittent operation flag is strongly correlated with the fluctuation in V₂(t). Therefore, even if the averaged FC intermittent operation flag is used instead of V₂(t), Yₘ(X₁, X₂) can be estimated with high accuracy.

The same applies for the FC power, air flow rate, and the like. These parameters have a positive correlation with V₂(t). That is, basically, there is a relation that the larger V₂(t) is, the larger these parameters become. Therefore, even if these parameters are used as X₁(t) instead of V₂(t), Yₘ(X₁, X₂) can be estimated highly accurately.

### [2.1.5. Second Feature Amount X₂(t)]

The “second feature amount X₂(t)” refers to any one or more parameters selected from a group consisting of an outside air temperature T(t) and parameters correlated therewith.

The “correlated parameter” refers to a parameter which can be identified as equivalent to the outside air temperature T(t) or a parameter which can be converted to the outside air temperature T(t).

X₂(t) is the other of the two parameters for calculating the temporary fluctuation Yₘ(X₁, X₂) in cell voltage.

The temporary fluctuation in cell voltage is caused not only by the fluctuation in the power required for the fuel cell, but also by a fluctuation in the outside air temperature T(t). Further, the fluctuation in T(t) affects not only the power generation efficiency of the fuel cell, but also the power consumption of the fuel cell's auxiliary equipment. Therefore, T(t) has a strong correlation with the temporary fluctuation in cell voltage. By using T(t) as X₂(t), Yₘ(X₁, X₂) can be estimated with high accuracy.

Note that when estimating Yₘ(X₁, X₂), another parameter correlated with T(t) may be used as the second feature amount X₂(t) instead of or in addition to T(t).

Specific examples of such parameters include the following. For X₂(t), any one of the following parameters may be used, or two or more of the parameters may be used in combination.
(a) The temperature of the coolant water at the outlet of a radiator for cooling the fuel cell.
(b) The motor temperature of the air compressor for supplying air to the cathode of the fuel cell.
(c) The inverter temperature of the air compressor for supplying air to the cathode of the fuel cell.
(d) The motor temperature of the hydrogen pump for supplying hydrogen to the anode of the fuel cell.
(e) The temperature of the coolant water discharged from the fuel cell (FC outlet coolant water temperature).
(f) The temperature of each auxiliary component other than those described above.

For example, when X₂(t) is the coolant water temperature at the outlet of the radiator for cooling the fuel cell, the fluctuation in the coolant water temperature is strongly correlated with the fluctuation in T(t). In general, the higher T(t) is, the higher the coolant water temperature becomes. Therefore, even if the coolant water temperature is used instead of T(t), Yₘ(X₁, X₂) can be estimated with high accuracy.

The same applies for the motor temperature of the air compressor, the inverter temperature of the air compressor, and the like. These parameters have a positive correlation with T(t). That is, basically, there is a relation that the higher T(t) is, the larger these parameters become. Therefore, even if these parameters are used as X₂(t) instead of T(t), Yₘ(X₁, X₂) can be estimated with high accuracy.

### 2.2. Second Means

The second means includes means for extracting, from the output data, the time t and first cell voltage V₁(t) when the FC current i(t) is the representative current iᵣ, calculating the representative I-V characteristic V_{f}(t, iᵣ) using these, and storing the same in the memory.

The “representative I-V characteristic V_{f}(t, iᵣ)” refers to a group of data which indicates the relationship between the time t and cell voltage V(t) when the FC current i(t) is a representative current iᵣ.

The “representative current iᵣ” refers to the FC current i(t) which serves as the reference when comparing the cell voltage V(t) at the time of a non-malfunction with the cell voltage V(t) at the time of a malfunction in the case of performing the malfunction detection and deterioration estimation.

The representative current iᵣ may be one, or two or more. In other words, the malfunction detection can be made as follows:
(a) A malfunction may be determined when V_{f}(t, iᵣ) for any one of the representative currents iᵣ (for example, when iᵣ=0.2 A/cm²) satisfies the condition to be described below, or
(b) A malfunction may be determined when V_{f}(t, iᵣ) for two or more representative currents iᵣ (for example, when iᵣ=0.2 A/cm², 0.4 A/cm², and 0.6 A/cm²) each simultaneously satisfy the conditions described below.
   [2.2.1. Calculation of I-V Characteristic at an Arbitrary Time t]

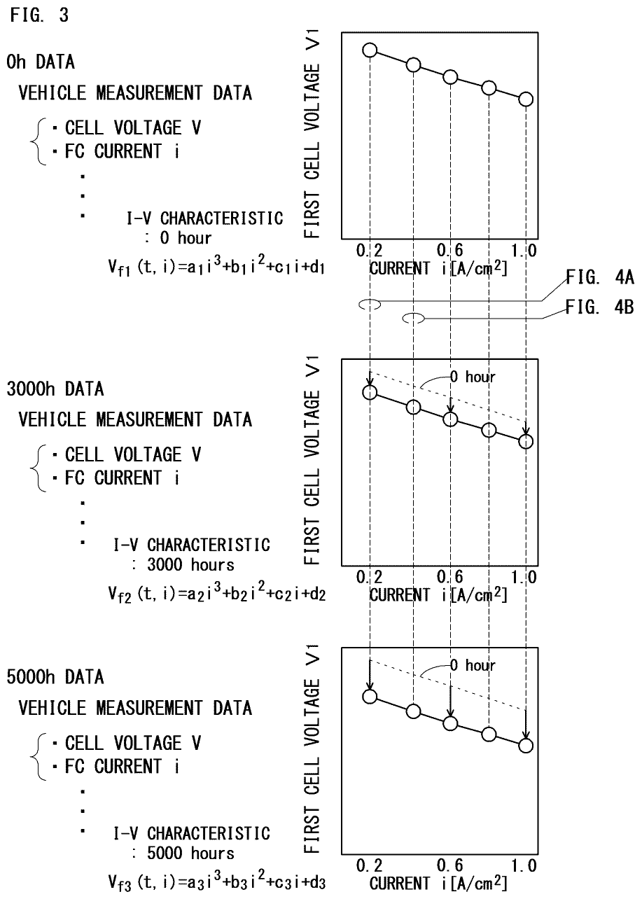

FIG. 3 shows a schematic diagram of a method for calculating the I-V characteristic at an arbitrary time t from the driving data of a vehicle equipped with a fuel cell. After completion of the fuel cell vehicle, when the vehicle is actually driven, the cell voltage V(t), the FC current i(t), etc. change every moment depending on the driving conditions. These are sequentially stored in the memory as vehicle measurement data.

When the vehicle is actually driven, the power generating conditions of the fuel cell vary in various ways from a state of a light load (low current, high voltage) to a state of a high load (high current, low voltage). On the other hand, the aging deterioration of the electrode catalyst progresses gradually. Therefore, regarding the aging deterioration of the electrode catalyst, data being present within a certain time interval (time t±α) can be regarded as “data at a certain time t”.

Therefore, when extracting various data consisting of combinations of the FC current i(t) and the first cell voltage V₁(t) from the data within the time (t±α), the I-V characteristic at a certain time t can be obtained. The value of a is not particularly limited, and the optimum value can be selected depending on the purpose. The value of α is usually about 1 hour to 10 hours.

The upper diagram of FIG. 3 shows an example of the I-V characteristic when the running time is 0 h (i.e., when the running time can be considered to be 0 h). Each “o” indicates extracted data. In the example shown in FIG. 3, the first cell voltage V₁(t) when the FC current i(t) is 0.2, 0.4, 0.6, 0.8, and 1.0 A/cm² is shown. When approximating these data with an appropriate function, it is possible to calculate the first cell voltage V₁(t) when the running time is 0 h and at an arbitrary current i(t). For example, when approximating these data with a cubic function, the I-V characteristic when the running time is 0 h is expressed by the following equation (1.1).

$${V}_{f 1} ( t , i ) = {a}_{1} {i}^{3} + {b}_{1} {i}^{2} + {c}_{1} i + {d}_{1} \qquad ( 1.1 )$$

where
V_{f1}(t, i) is the first cell voltage when the running time is 0 h and the FC current is i(t), and
a₁, b₁, c₁, and d₁ are respectively coefficients identified for each running time.

The middle and lower diagrams of FIG. 3 show examples of I-V characteristics when the running time is 3000 h and 5000 h, respectively. The same applies when the running time is 3000 h or 5000 h. That is, various data consisting of combinations of the FC current i(t) and the first cell voltage V₁(t) which can be regarded as data for a running time of 3000 h or 5000 h are extracted from the accumulated data, and these are approximated by an appropriate function. For example, when approximating these data with a cubic function, the I-V characteristics when the running time is 3000 h or 5000 h are expressed by the following equation (1.2) or (1.3), respectively.

$${V}_{f 2} ( t , i ) = {a}_{2} {i}^{3} + {b}_{2} {i}^{2} + {c}_{2} i + {d}_{2} \qquad ( 1.2 )$$

where
V_{f2}(t, i) is the first cell voltage when the running time is 3000 h and the FC current is i(t).
a₂, b₂, c₂, and d₂ are respectively coefficients identified for each running time.

$${V}_{f 3} ( t , i ) = {a}_{3} {i}^{3} + {b}_{3} {i}^{2} + {c}_{3} i + {d}_{3} \qquad ( 1.3 )$$

where
V_{f3}(t, i) is the first cell voltage when the running time is 5000 h and the FC current is i(t).
a₃, b₃, c₃, and d₃ are respectively coefficients identified for each running time.

Incidentally, in general, the longer the running time, the more the aging deterioration of the electrode catalyst progresses. Therefore, V_{f2}(t, i) usually becomes a value lower than V_{f1}(t, i). Similarly, V_{f3}(t, i) usually becomes a value lower than V_{f2}(t, i).

### [2.2.2. Calculation of Representative I-V Characteristic]

When the I-V characteristic at an arbitrary time t is known, it is possible to recognize the time t and the first cell voltage V₁(t) when the FC current i(t) is the representative current iᵣ. Further, once these are known, they can be used to calculate the representative I-V characteristic V_{f}(t, iᵣ).

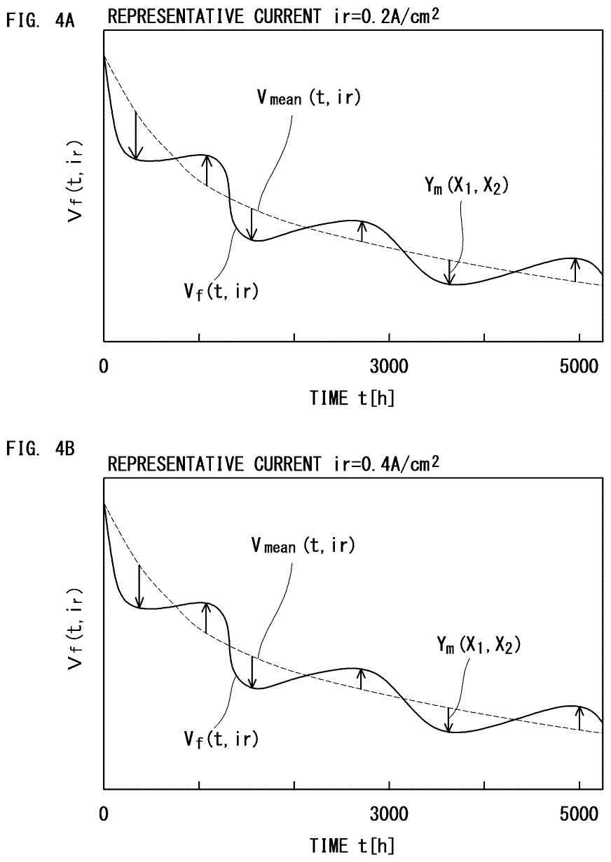

FIG. 4A shows an example of the change over time of the representative I-V characteristic V_{f}(t, iᵣ) when the representative current iᵣ=0.2 A/cm². FIG. 4B shows an example of the change over time of the representative I-V characteristic V_{f}(t, iᵣ) when the representative current iᵣ=0.4 A/cm². FIGS. 4A and 4B respectively show that the first cell voltage V₁(t) when the FC current i(t) is 0.2 A/cm² or 0.4 A/cm² is extracted from the data shown in FIG. 3, and V₁(t) is plotted against the time t.

The representative I-V characteristic V_{f}(t, iᵣ) includes the temporary fluctuation Yₘ(X₁, X₂) in cell voltage and the component Vₘₑₐₙ(t, iᵣ) other than that. Vₘₑₐₙ(t, iᵣ) usually consists only of a drop in cell voltage due to the aging deterioration of the electrode catalyst. However, when the fuel cell malfunctions, the drop in cell voltage due to the malfunction is further added to Vₘₑₐₙ(t, iᵣ).

Therefore, in order to accurately determine the malfunction, there is a need to subtract Yₘ(X₁, X₂) from V_{f}(t, iᵣ) to separate Vₘₑₐₙ(t, iᵣ). To do that, it is first necessary to know Yₘ(X₁, X₂).

### 2.3. Third Means

The third means includes means for extracting from the output data, the time t, the first feature amount X₁(t), and the second feature amount X₂(t) when the FC current i(t) is a representative current iᵣ, calculating the temporary fluctuation Yₘ(X₁, X₂) in cell voltage using these, and storing the same in the memory.

For a fuel cell having the same specifications as the fuel cell to be controlled, a function indicating the relationship between Yₘ and X₁ and X₂, or its equivalent is obtained in advance, and stored in the memory.

Upon actual malfunction detection, first, from the accumulated data, the following when the FC current i(t) is the representative current iᵣ are extracted:
(a) a time t,
(b) a first feature amount X₁(t) including a second cell voltage V₂(t) and/or a parameter equivalent thereto, and
(c) a second feature amount X₂(t) including the outside air temperature T(t) and/or a parameter equivalent thereto.

Next, X₁(t) and X₂(t) are substituted into a previously obtained function or its equivalent to calculate Yₘ(X₁, X₂).

The method of calculating Yₘ(X₁, X₂) is not particularly limited, and the optimum method can be selected depending on the purpose. Specifically, the method of calculating Yₘ(X₁, X₂) includes the following methods.

### [2.3.1. Method Using Multiple Regression Model]

The third means may include means for calculating Yₘ(X₁, X₂) using the following equation (2).

$${Y}_{m} ( {X}_{1} , {X}_{2} ) = {a}_{0} + Σ {a}_{1 p} {{X}_{1} ( t )}^{p} + Σ {a}_{2 q} {{X}_{2} ( t )}^{q} \qquad ( 2 )$$

where
p and q are each an integer of 1 or more, and
a₀, a₁ₚ, and a_{2g} are respectively coefficients identified for each representative current iᵣ.

The analysis of vehicle measurement data by the inventors of the present application has revealed that the temporary fluctuation Y in cell voltage is highly correlated with the first feature amount X₁(t) and the second feature amount X₂(t). The equation (2) is a multiple regression model obtained based on such findings, in which Yₘ (estimated value of Y) is approximated by the sum of a p order polynomial of X₁(t) and a q order polynomial of X₂(t).

When calculating Yₘ(X₁, X₂) using the equation (2), a test is performed in advance on a fuel cell having the same specifications as the fuel cell being the subject of malfunction detection, and the orders p and q of X₁(t) and X₂(t) and the coefficients a₀, a₁ₚ, and a_{2q} are identified so that the actual fluctuation Y in cell voltage when X₁(t) and X₂(t) fluctuate coincides with the fluctuation Yₘ of the model equation expressed by the equation (2). Each coefficient is identified for each representative current iᵣ. Further, these identified coefficients are stored in the memory.

In the actual malfunction detection, the obtained X₁(t) and X₂(t) are substituted into the equation (2). Consequently, Yₘ(X₁, X₂) when the FC current i(t) is the representative current iᵣ can be calculated with respect to an arbitrary time t.

### [2.3.2. Method Using Neural Network]

The third means may include means for calculating Yₘ(X₁, X₂) using a neural network.

A prediction model is constructed in advance by using the neural network to learn the relationship between Yₘ and X₁ and X₂ for a fuel cell having the same specifications as the fuel cell being the subject of malfunction detection.

In the actual malfunction detection, the obtained X₁(t) and X₂(t) are input to the constructed prediction model. Consequently, Yₘ(X₁, X₂) when the FC current i(t) is the representative current iᵣ can be output with respect to an arbitrary time t.

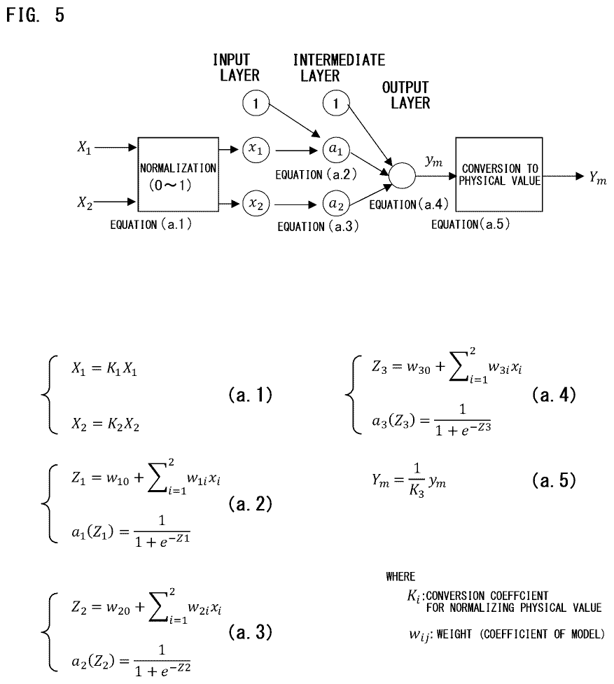

FIG. 5 shows a schematic diagram of a method for calculating Yₘ(X₁, X₂) using the neural network. FIG. 5 is an example of a neural network, which becomes a model for predicting Yₘ for the feature amounts X₁ and X₂.

### 2.4. Fourth Means

The fourth means includes means for calculating the average I-V characteristic Vₘₑₐₙ(t, iᵣ) at the time t by subtracting Yₘ(X₁, X₂) from V_{f}(t, iᵣ), and storing the same in the memory.

The “average I-V characteristic Vₘₑₐₙ(t, iᵣ)” refers to a group of data indicating the relationship between a time t and a cell voltage V excluding the temporary cell voltage fluctuation when the FC current i(t) is a representative current iᵣ.

Upon the non-malfunction, Vₘₑₐₙ(t, iᵣ) ideally includes only the drop in cell voltage due to the aging deterioration of the electrode catalyst. Upon the malfunction, however, Vₘₑₐₙ(t, iᵣ) becomes a value obtained by adding the drop in cell voltage due to the malfunction to the drop in cell voltage due to the aging deterioration of the electrode catalyst. Therefore, the use of Vₘₑₐₙ(t, iᵣ) enables accurate malfunction detection.

### 2.5. Fifth Means

The fifth means includes means for determining whether or not the fuel cell has malfunctioned or deteriorated, on the basis of Vₘₑₐₙ(t, iᵣ).

In the present invention, the malfunction detection method using Vₘₑₐₙ(t, iᵣ) is not particularly limited, and the optimum method can be selected depending on the purpose. Specific examples of the malfunction detection method include the following. Any one of these may be used, or two or more of them may be used in combination as far as physically possible.

[2.5.1. Malfunction Detection Method Using dVₘₑₐₙ(t, iᵣ)/Dt]

The fifth means may include means for
sequentially calculating the rate of decrease dVₘₑₐₙ(t, iᵣ)/dt of Vₘₑₐₙ(t, iᵣ), and
determining that the fuel cell has malfunctioned when any one or more of the following equations (3.1) to (3.6) are satisfied.

$$\vert {dv}_{m e a n} ( t , {i}_{r} ) / dt - d {v}_{m e a n} ( t - m , {i}_{r} ) / dt \vert > {ε}_{31} \qquad ( 3.1 )$$

$$\vert {dv}_{m e a n} ( t , {i}_{r} ) / dt - d {v}_{m e a n} ( t - m , {i}_{r} ) / dt \vert \geq {ε}_{31} \qquad ( 3.2 )$$

$$\vert [ {dv}_{m e a n} ( t , {i}_{r} ) / dt ] / [ {dv}_{m e a n} ( t - m , {i}_{r} ) / dt ] \vert > {ε}_{32} \qquad ( 3.3 )$$

$$\vert [ {dv}_{m e a n} ( t , {i}_{r} ) / dt ] / [ {dv}_{m e a n} ( t - m , {i}_{r} ) / dt ] \vert \geq {ε}_{32} \qquad ( 3.4 )$$

$$\vert {dv}_{m e a n} ( t , {i}_{r} ) / dt \vert > {ε}_{33} \qquad ( 3.5 )$$

$$\vert {dv}_{m e a n} ( t , {i}_{r} ) / dt \vert \geq {ε}_{33} \qquad ( 3.6 )$$

where
dVₘₑₐₙ(t−m, iᵣ)/dt is the rate of decrease of the average I-V characteristic Vₘₑₐₙ(t−m, iᵣ) at a time (t−m) (m>0), and
ε₃₁, ε₃₂, and ε₃₃ are thresholds for determining the presence or absence of a malfunction, respectively.

The “t−m” indicates the time when past data is acquired to compare with the current data acquired at a time t. The value of m is not particularly limited, and the optimum value can be selected depending on the purpose.

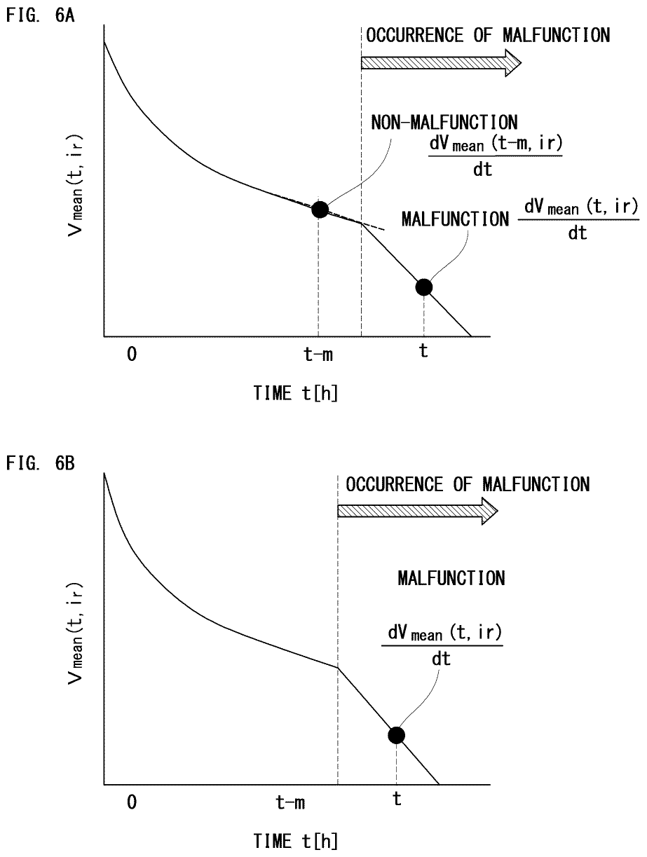

FIG. 6A shows a schematic diagram of a malfunction detection method using the rate of decrease dVₘₑₐₙ(t, iᵣ)/dt of Vₘₑₐₙ(t, iᵣ) at a time t and the rate of decrease dVₘₑₐₙ(t−m, iᵣ)/dt of Vₘₑₐₙ(t−m, iᵣ) at a time (t−m). FIG. 6B shows a schematic diagram of a malfunction detection method using only the rate of decrease dVₘₑₐₙ(t, iᵣ)/dt of Vₘₑₐₙ(t, iᵣ) at the time t.

As described above, when the malfunction occurs, Vₘₑₐₙ(t, iᵣ) is added with the decrease in cell voltage due to the malfunction. Therefore, Vₘₑₐₙ(t, iᵣ) becomes smaller than the value expected based only on the aging deterioration of the electrode catalyst. As a result, as shown in FIG. 6, dVₘₑₐₙ(t, iᵣ)/dt becomes a larger negative value than the value expected based only on the aging deterioration of the electrode catalyst.

Therefore, as shown in the equation (3.1) or (3.2), when the absolute value of the difference between dVₘₑₐₙ(t, iᵣ)/dt at the current time t and dVₘₑₐₙ(t−m, iᵣ)/dt at a certain time (t−m) in the past exceeds a certain threshold &31 or is equal to or greater than ε₃₁, it can be determined that the malfunction has occurred (FIG. 6A).

Alternatively, as shown in the equation (3.3) or (3.4), when the absolute value of the ratio of dVₘₑₐₙ(t, iᵣ)/dt to dVₘₑₐₙ(t−m, iᵣ)/dt exceeds a certain threshold ε₃₂ or is equal to or greater than ε₃₁, it can be determined that the malfunction has occurred (FIG. 6A).

Alternatively, as shown in the equation (3.5) or (3.6), when the absolute value of dVₘₑₐₙ(t, iᵣ)/dt exceeds a certain threshold ε₃₃ or is equal to or greater than ε₃₃, it can be determined that the malfunction has occurred (FIG. 6B).

On the other hand, when no malfunction is detected, Vₘₑₐₙ(t, iᵣ) represents an estimated value of the IV characteristic which has considered the decrease in cell voltage due to the aging deterioration of the electrode catalyst.

Therefore, Vₘₑₐₙ(t, iᵣ) can be used to deterioration estimation, fuel consumption prediction, cruising distance prediction, and so on.

[2.5.2. Malfunction Detection Method Using Non-Malfunction Model Vₙ(t, iᵣ)]

The memory may store a non-malfunction model Vₙ(t, iᵣ) when the FC current i(t) is the representative current iᵣ.

In this case, the fifth means may include means for determining that the fuel cell has malfunctioned when any one or more of the following equations (4.1) to (4.4) are satisfied.

$$\vert {V}_{m e a n} ( t , {i}_{r} ) - {V}_{n} ( t , {i}_{r} ) \vert > {ε}_{41} \qquad ( 4.1 )$$

$$\vert {V}_{m e a n} ( t , {i}_{r} ) - {V}_{n} ( t , {i}_{r} ) \vert \geq {ε}_{41} \qquad ( 4.2 )$$

$$\vert {V}_{m e a n} ( t , {i}_{r} ) / {V}_{n} ( t , {i}_{r} ) \vert < {ε}_{42} \qquad ( 4.3 )$$

$$\vert {V}_{m e a n} ( t , {i}_{r} ) / {V}_{n} ( t , {i}_{r} ) \vert \leq {ε}_{42} \qquad ( 4.4 )$$

where
ε₄₁ and ε₄₂ are each a threshold for determining the presence or absence of a malfunction.
   [A. Non-Malfunction Model Vₙ(t, iᵣ)]

The “non-malfunction model Vₙ(t, iᵣ)” refers to a model which shows the relationship between the use history of a fuel cell with the same specifications as the fuel cell being the subject of malfunction detection, and the drop in cell voltage due to the aging deterioration of the electrode catalyst. In other words, the non-malfunction model Vₙ(t, iᵣ) refers to a model which shows the relationship between the use history and the cell voltage when it is assumed that no malfunction has occurred.

Vₙ(t, iᵣ) is not particularly limited as long as it is possible to derive the relationship between the use history and the cell voltage. For example, Vₙ(t, iᵣ) includes the following:
(a) a physical model, and
(b) a model in which V_{f}(t, iᵣ) from time zero to the time t is approximated by an r order polynomial (where r is an integer being 1 or higher or 10 or lower).

### [A. 1. Physical Model]

Vₙ(t, iᵣ) may be a physical model. The “physical model” refers to a model which is capable of estimating the aging deterioration of the electrode catalyst using a theoretical equation and estimating the cell voltage V(t) at the time t, on the basis of the estimated aging deterioration of the electrode catalyst.

For example, Reference 1 discloses a method for predicting the deterioration of a fuel cell catalyst. Using the method described in the Reference 1, it is possible to estimate a surface area ECSA(t) of a platinum catalyst at a time t when the cell voltage V(t), FC current i(t), and cell temperature T(t) at the time t are given. Further, substituting the obtained ECSA(t) into the following equation (5) makes it possible to calculate the cell voltage Vₙ(t, iᵣ) at the time of non-malfunction at an arbitrary time t when the FC current i(t) is a representative current iᵣ.
[Reference 1] Japanese Unexamined Patent Application Publication No. 2010-236989

$${V}_{n} ( t , {i}_{r} ) = V ( 0 , {i}_{r} ) + K \cdot ln \{ ECSA ( t ) / ECSA ( 0 ) \} \qquad ( 5 )$$

where
Vₙ(t, iᵣ) is a cell voltage [V] at the time t when there is non-malfunction,
iᵣ is a representative current [A/cm²],
t is the time [s], and
K is a constant.

### [A. 2. r Order Polynomial]

Vₙ(t, iᵣ) may be a model obtained by approximating V_{f}(t, iᵣ) from time zero to the time t using the r order polynomial (where r is an integer being 1 or higher or 10 or lower).

When V_{f}(t, iᵣ) including the temporary fluctuation in cell voltage is approximated by the r order polynomial (relatively low order polynomial), an average I-V characteristic is obtained in which the temporary fluctuation in cell voltage is cancelled out. When the malfunction does not occur, the I-V characteristic approximated by the r order polynomial becomes a shape similar to Vₘₑₐₙ(t, iᵣ) which does not include the drop in cell voltage due to the malfunction.

However, when the malfunction occurs, the I-V characteristic approximated by the r order polynomial is approximated using data including both the I-V characteristic before the malfunction and the I-V characteristic after the malfunction. Therefore, it is hard for the r order polynomial to reflect the drop in cell voltage due to the malfunction immediately after the malfunction occurs. On the other hand, Vₘₑₐₙ(t, iᵣ) immediately reflects the drop in cell voltage due to the malfunction. Therefore, it is possible to determine the presence or absence of a malfunction by comparing the I-V characteristic approximated by the r order polynomial with Vₘₑₐₙ(t, iᵣ).

### [A. 3 Detection Method]

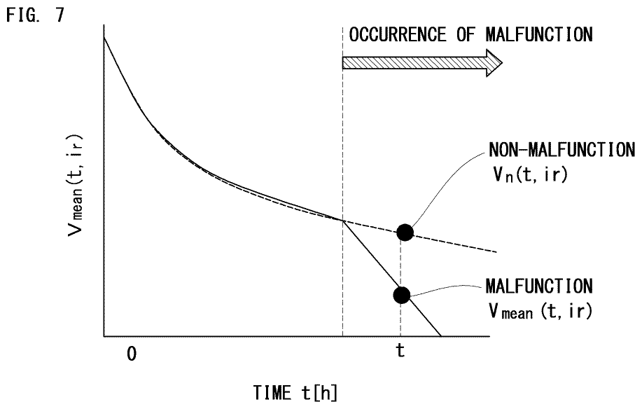

FIG. 7 shows a schematic diagram of a malfunction detection method using a non-malfunction model Vₙ(t, iᵣ). As shown in FIG. 7, when a malfunction occurs, Vₘₑₐₙ(t, iᵣ) becomes lower than Vₙ(t, iᵣ). Therefore, as shown in the equation (4.1) or (4.2), when the absolute value of the difference between Vₘₑₐₙ(t, iᵣ) at the current time t and Vₙ(t, iᵣ) exceeds a certain threshold ε₄₁ or is equal to or greater than ε₄₁, it can be determined that the malfunction has occurred.

Alternatively, as shown in the equation (4.3) or (4.4), when the absolute value of the ratio of Vₘₑₐₙ(t, iᵣ) to Vₙ(t, iᵣ)/dt is less than a certain threshold ε₄₂ or is equal to or less than ε₄₂, it can be determined that the malfunction has occurred.

On the other hand, when no malfunction is detected, not only Vₘₑₐₙ(t, iᵣ) but also Vₙ(t, iᵣ) represent an estimate value of the I-V characteristic having considered the drop in cell voltage due to the aging deterioration of the electrode catalyst.

Therefore, Vₘₑₐₙ(t, iᵣ) or Vₙ(t, iᵣ) can be used to perform deterioration estimation, fuel consumption prediction, cruising distance prediction, etc.

### 4. Effects

First, the FC current i(t), the first cell voltage V₁(t), the first feature amount X₁(t), and the second feature amount X₂(t), which change from moment to moment, are obtained and stored in the memory.

Next, the time t and V₁(t) when the FC current i(t) is a representative current iᵣ (for example, when iᵣ=0.2 A/cm²) are read from the memory, and the change in cell voltage over time when i(t) is iᵣ, i.e., the representative I-V characteristic V_{f}(t. iᵣ) is calculated.

Similarly, the time t, X₁(t), and X₂(t) when the FC current i(t) is the representative current iᵣ are read from the memory, and the temporary fluctuation Yₘ(X₁, X₂) in cell voltage when i(t) is iᵣ is calculated.

Further, the average I-V characteristic Vₘₑₐₙ(t, iᵣ) is calculated by subtracting Yₘ(X₁, X₂) from the obtained V_{f}(t, iᵣ).

Upon non-malfunction, V(t, iᵣ) includes the drop in cell voltage due to the aging deterioration of the electrode catalyst, and the temporary fluctuation Yₘ(X₁, X₂) in cell voltage. Also, when the fuel cell malfunctions, V_{f}(t, iᵣ) is further added with the drop in cell voltage due to the malfunction. Therefore, even if malfunction diagnosis is performed using only V_{f}(t, iᵣ), it is difficult to perform accurate malfunction diagnosis.

In contrast, when there is no malfunction, Vₘₑₐₙ(t, iᵣ) includes only the drop in cell voltage due to the aging deterioration of the electrode catalyst. Further, when the fuel cell malfunctions, Vₘₑₐₙ(t, iᵣ) is further added with the drop in cell voltage due to the malfunction. Therefore, if the change in Vₘₑₐₙ(t, iᵣ) is monitored sequentially, it is possible to determine the presence or absence of the malfunction from the amount of change in Vₘₑₐₙ(t, iᵣ). On the other hand, when no malfunction is detected, it is possible to estimate the deterioration of the fuel cell and the IV performance on the basis of Vₘₑₐₙ(t, iᵣ).

The embodiments of the present invention have been described above in detail, but the present invention is not limited to the above embodiment, and various modifications are possible within the scope not departing from the spirit of the present invention.

### INDUSTRIAL APPLICABILITY

The malfunction detection and deterioration estimation device according to the present invention can be used for malfunction determination, deterioration estimation, fuel consumption prediction, cruising distance prediction, etc. of the fuel cell of the vehicle equipped with the fuel cell.

1. A malfunction detection and deterioration estimation device including the following configurations:
(A) first means for sequentially obtaining output data of a fuel cell at a time t, the output data including
(a) an FC current i(t),
(b) a first cell voltage V₁ (t),
(c) a first feature amount X₁ (t) including any one or more selected from a group consisting of a second cell voltage V₂ (t) and parameters correlated therewith, and
(d) a second feature amount X₂(t) including any one or more selected from a group consisting of an outside air temperature T(t) and parameters correlated therewith, and
storing the output data in a memory,
where the “first cell voltage V₁ (t)” refers to among cell voltages of the fuel cell at all times, the cell voltage when the fuel cell is in an intermittent operation OFF state, and
the “second cell voltage V₂ (t)” refers to the cell voltages of the fuel cell at all times;
(B) second means for extracting from the output data, the time t and the first cell voltage V₁ (t) when the FC current i(t) is a representative current iᵣ, calculating a representative I-V characteristic V_{f}(t, iᵣ) using these, and storing the same in the memory;
(C) third means for extracting from the output data, the time t, the first feature amount X₁ (t), and the second feature amount X₂(t) when the FC current i(t) is the representative current iᵣ, calculating a temporary fluctuation Yₘ(X₁, X₂) in cell voltage using these, and storing the same in the memory;
(D) fourth means for calculating an average I-V characteristic Vₘₑₐₙ(t, iᵣ) at the time t by subtracting Yₘ(X₁, X₂) from V_{f}(t, iᵣ), and storing the same in the memory; and
(E) fifth means for determining whether or not the fuel cell has malfunctioned or deteriorated, on the basis of Vₘₑₐₙ(t, iᵣ).

2. The malfunction detection and deterioration estimation device according to claim 1, wherein
the parameters correlated with V₂ (t) include any one or more selected from a group consisting of an FC intermittent operation flag, FC power, an air flow rate, a motor rotation speed of an air compressor, power consumption of a hydrogen pump, a rotation speed of the hydrogen pump, FC inlet pressure (anode), a rotation speed of an EV cooling water pump, a rotation speed of an FC cooling water pump, an FC converter current, power required for a vehicle system, a current value required for the vehicle system, FC inlet pressure (cathode), an anode gas flow rate, power consumption of the air compressor, an FC power generation status, and A/C power consumption.

3. The malfunction detection and deterioration estimation device according to claim 1, wherein
the parameters correlated with T(t) include any one or more selected from a group consisting of a coolant water temperature of a radiator outlet, a motor temperature of an air compressor, an inverter temperature of the air compressor, a motor temperature of a hydrogen pump, an FC outlet coolant water temperature, and a temperature of each auxiliary component.

4. The malfunction detection and deterioration estimation device according to claim 1, wherein
the third means includes means for calculating Yₘ(X₁, X₂) using a following equation (2):
$${Y}_{m} ( {X}_{1} , {X}_{2} ) = {a}_{0} + Σ {a}_{1 p} {{X}_{1} ( t )}^{p} + Σ {a}_{2 q} {{X}_{2} ( t )}^{q} \qquad ( 2 )$$
where
p and q are each an integer of 1 or more, and
a₀, a₁ₚ, and a_{2g} are each a coefficient identified for each representative current iᵣ.

5. The malfunction detection and deterioration estimation device according to claim 1, wherein
the third means includes means for calculating Yₘ(X₁, X₂) using a neural network.

6. The malfunction detection and deterioration estimation device according to claim 1, wherein
the fifth means includes means for
sequentially calculating the rate of decrease dVₘₑₐₙ(t, iᵣ)/dt of Vₘₑₐₙ(t, iᵣ) and
determining that the fuel cell has malfunctioned when any one or more of following equations (3.1) to (3.6) are satisfied:
$$\vert {dv}_{m e a n} ( t , {i}_{r} ) / dt - d {v}_{m e a n} ( t - m , {i}_{r} ) / dt \vert > {ε}_{31} \qquad ( 3.1 )$$
$$\vert {dv}_{m e a n} ( t , {i}_{r} ) / dt - d {v}_{m e a n} ( t - m , {i}_{r} ) / dt \vert \geq {ε}_{31} \qquad ( 3.2 )$$
$$\vert [ {dv}_{m e a n} ( t , {i}_{r} ) / dt ] / [ {dv}_{m e a n} ( t - m , {i}_{r} ) / dt ] \vert > {ε}_{32} \qquad ( 3.3 )$$
$$\vert [ {dv}_{m e a n} ( t , {i}_{r} ) / dt ] / [ {dv}_{m e a n} ( t - m , {i}_{r} ) / dt ] \vert \geq {ε}_{32} \qquad ( 3.4 )$$
$$\vert {dv}_{m e a n} ( t , {i}_{r} ) / dt \vert > {ε}_{33} \qquad ( 3.5 )$$
$$\vert {dv}_{m e a n} ( t , {i}_{r} ) / dt \vert \geq {ε}_{33} \qquad ( 3.6 )$$
where
dVₘₑₐₙ(t−m, iᵣ)/dt is the rate of decrease of the average I-V characteristic Vₘₑₐₙ(t−m, iᵣ) at a time (t−m) (m>0), and
ε₃₁, ε₃₂, and ε₃₃ are thresholds for determining the presence or absence of a malfunction, respectively.

7. The malfunction detection and deterioration estimation device according to claim 1, wherein
the memory stores a non-malfunction model Vₙ(t, iᵣ) when the FC current i(t) is the representative current iᵣ, and
the fifth means includes means for determining that the fuel cell has malfunctioned when any one or more of following equations (4.1) to (4.4) are satisfied:
$$\vert {V}_{m e a n} ( t , {i}_{r} ) - {V}_{n} ( t , {i}_{r} ) \vert > {ε}_{41} \qquad ( 4.1 )$$
$$\vert {V}_{m e a n} ( t , {i}_{r} ) - {V}_{n} ( t , {i}_{r} ) \vert \geq {ε}_{41} \qquad ( 4.2 )$$
$$\vert {V}_{m e a n} ( t , {i}_{r} ) / {V}_{n} ( t , {i}_{r} ) \vert < {ε}_{42} \qquad ( 4.3 )$$
$$\vert {V}_{m e a n} ( t , {i}_{r} ) / {V}_{n} ( t , {i}_{r} ) \vert \leq {ε}_{42} \qquad ( 4.4 )$$
where the “non-malfunction model Vₙ(t, iᵣ)” is a model indicating the relationship between a use history of a fuel cell with the same specifications as the fuel cell being the subject of malfunction detection and deterioration estimation, and a drop in cell voltage due to aging deterioration of an electrode catalyst, and
ε₄₁ an ε₄₂ are thresholds for determining the presence or absence of a malfunction.

8. The malfunction detection and deterioration estimation device according to claim 7, wherein
the Vₙ(t, iᵣ) is
(a) a physical model or
(b) a model in which V_{f}(t, iᵣ) from time zero to the time t is approximated by an r order polynomial (where r is an integer being 1 or higher or 10 or lower).
